(19) United States
(12) Patent Application Publication
(10) Pub. No.: US 2010/0307689 A1
(43) Pub. Date: Dec. 9, 2010

(54) Pivoting tape dispenser

(76) Inventor: Michael James Huebner, Marietta, GA (US)

Correspondence Address: Robert Z. Evora, 4741 Planters Walk, Douglasville, GA, 30135, US

(21) Appl. No.: 12/802,399

(22) Filed: Jun. 7, 2010

Related U.S. Application Data
(60) Provisional application No. 61/217,898, filed on Jun. 6, 2009.

(51) Int. Cl. B32B 37/02

(52) U.S. Cl. 156/510

(57) ABSTRACT

A variable tension tape pivoting dispenser having an ergonomic handle, a pivot arm and an adjustable bias element. The ergonomic handle includes a tape roll mount connected to the handle at a first pivot. A tape roll is concentrically disposed on the tape roll mount. The pivot arm has a first end and a second dispensing end. The first end is connected to the handle at a second pivot, and a swath of tape extends from the tape roll to the second dispensing end on the pivot arm. The adjustable bias element is disposed at the second pivot and is adapted to provide variable resistance to the rotation of the pivot arm relative to the handle. In use, the angle of the handle remains substantially unchanged in position as the swath of tape being dispensed from the second dispensing end of the pivot arm is adapted to traverse onto various surfaces oriented at various angles upon which the swath of tape is being applied.

### CROSS REFERENCE TO RELATED APPLICATION

This application is a Non-Provisional Application which claims the benefit of the filing date of U.S. Provisional Application Ser. No. 61/217,898 entitled “Pivoting Tape Dispenser” filed Jun. 6, 2009, the entirety of which is incorporated herein by reference.

### BACKGROUND

1. Field of the Invention

This concept relates to a tape dispenser, and more particularly, to an ergonomic variable resistant pivoting adhesive tape dispenser.

2. Description of the Related Art

Conventional adhesive tape dispensers include a fixed handle, a rigid spool carrying the adhesive tape affixed to a base fastened to the fixed handle, and a tape-cutting device fixedly mounted on the base. In order to dispense the adhesive tape over an object, such as a box, the user holding the conventional tape dispenser would have to awkwardly twist and turn their wrist over the various surfaces of the box. With numerous repetitions, this motion is quite cumbersome and can be painful to the wrist of the user.

FIG. 21 of U.S. Pat. No. 7,195,048 illustrates an example of a traditional tape dispenser employing conventional techniques for taping various surfaces of an object, such as a box. As shown, a user gripping the handle has to twist and contort their wrist in various uncomfortable positions in order to place an adhesive on the various surfaces of the box. Use of this conventional device is awkward and with repetition likely quite grueling on the user's hand.

Various conventional adhesive tape dispensers have been constructed, however, none before has been designed to eliminate the cumbersome, albeit tiresome and painful, twisting motion by a user's hand typical when using traditional adhesive tape dispensers. Furthermore, none of the traditional tape dispensers has provided a variable tension controlled and pivoting tape dispenser. There is still a longstanding need to solve these problems. Parcel packaging and delivery services can substantially benefit from a viable solution to these problems. In accordance with this invention, a flexible variable tension pivoting tape dispenser is described below.

### SUMMARY

In accordance with one exemplary embodiment, a pivoting tape dispenser includes an ergonomic handle, a pivot arm and an adjustable bias element. The ergonomic handle includes a tape roll mount connected to the handle at a first pivot. A tape roll is concentrically disposed on the tape roll mount. The pivot arm has a first end and a second dispensing end. The first end is connected to the handle at a second pivot, and a swath of tape extends from the tape roll to the second dispensing end on the pivot arm. The adjustable bias element is disposed at the second pivot and is adapted to provide variable resistance to the rotation of the pivot arm relative to the handle. In use, the angle of the handle remains substantially unchanged in position as the swath of tape being dispensed from the second dispensing end of the pivot arm is adapted to traverse onto various surfaces oriented at various angles upon which the swath of tape is being applied.

In another exemplary embodiment, the pivoting tape dispenser comprises a handle, a pivot arm and an adjustable bias element. The pivot arm includes a first end and a second dispensing end. The first end is connected to the handle at a pivot, and the swath of tape extends from the tape roll to the second dispensing end of the pivot arm. The adjustable bias element is disposed at the pivot that is adapted to provide variable resistance to the rotation of the pivot arm relative to the handle. Where, in use, the angle of the handle remains substantially unchanged in position as the pivot arm pivots over various surfaces in order to align and dispense the swath of tape over the various surfaces which are angled different from each other.

In yet another exemplary embodiment, a variable tension tape pivoting dispenser is disclosed. The variable tension tape pivoting dispenser includes an ergonomic handle having a first pivot point. A base portion extends from the ergonomic handle to a tape roll mount that receives a tape roll. A pivot arm includes a first end rotationally attached to the first pivot point and a dispensing second end. An adjustable bias element is disposed at the first pivot point and is adapted to provide variable resistance to the rotation of the pivot arm relative to the ergonomic handle. A pair of guide rollers is disposed adjacent to the dispensing second end of the pivot arm and are adapted to guide a swath of tape pulled from the tape roll to a dispensing end of the pivot arm. The swath of tape is fed over a press flange disposed adjacent to a cutting tool. In use, the ergonomic handle remains substantially in one position while the dispensing end of the pivot arm is adapted to rotate through a range of various angles suitable to lay the swath of tape onto an object being taped. A variable tension trigger mechanism having an actuator connected to a brake is included. When the variable tension trigger mechanism is depressed, a tension pressure is applied to at least one of the rotating components on the variable tension tape pivoting dispenser such that a gradually increase or decrease of pressure is applied making it harder or easier, respectively, to turn the rotating component.

These and other objects, features, and/or advantages may accrue from various aspects of embodiments, as described in more detail below.

### BRIEF DESCRIPTION OF THE DRAWINGS

Various exemplary embodiments will be described in detail, wherein like reference numerals refer to identical or similar components or steps, with reference to the following figures, wherein:

FIG. 1 depicts an exemplary relaxed side view of a pivoting tape dispenser.

FIG. 2 illustrates an exemplary extended side view of a pivoting tape dispenser.

FIG. 3 depicts an exploded perspective view of another exemplary embodiment for a pivoting tape dispenser showing a handle axially aligned with a spring, which in turn is axially aligned with a pivot arm.

FIG. 3A depicts an assembly view of another exemplary embodiment for a pivoting tape dispenser showing the handle connected to the pivot arm with a tape roll disposed therein.

FIG. 4 depicts a reverse assembly view of the pivoting tape dispenser showing the pivot extension handle disposed through the tape mount portion of the pivot arm.

FIG. 5 shows a first side view of the handle for the pivoting tape dispenser.

FIG. 6 illustrates a second inner side view of the handle for the pivoting tape dispenser.

FIG. 7 depicts a front view of the handle showing a pivot extension for a tape mount for the pivoting tape dispenser.

FIG. 8 shows a first side view of the pivot arm with a cutting tool and a press flange.

FIG. 9 depicts a reverse side view of the pivot arm illustrating the tape mount.

FIG. 10 shows a front view of the pivot arm illustrating the press guard and cutting tool.

FIG. 11 illustrates the reverse side view of the pivot arm including a tape roll mounted to the tape mount.

FIG. 12 illustrates the pivoting tape dispenser in use about a box.

FIG. 13 depicts another exemplary embodiment for the pivoting tape dispenser including an extendable pivoting arm.

FIG. 14 illustrates the integration of a pivot mechanism into another exemplary tape dispenser.

### DETAILED DESCRIPTION OF EXEMPLARY EMBODIMENTS

Particular embodiments will now be described in greater detail with reference to the figures.

It is to be understood that the pivoting adhesive tape dispenser described herein may be adapted for use in combination with various different types of configurations in addition to the various embodiments described and shown herein. Those described herein are not intended to limit the scope of the configuration and may cover all modifications and changes within the scope and spirit of the invention.

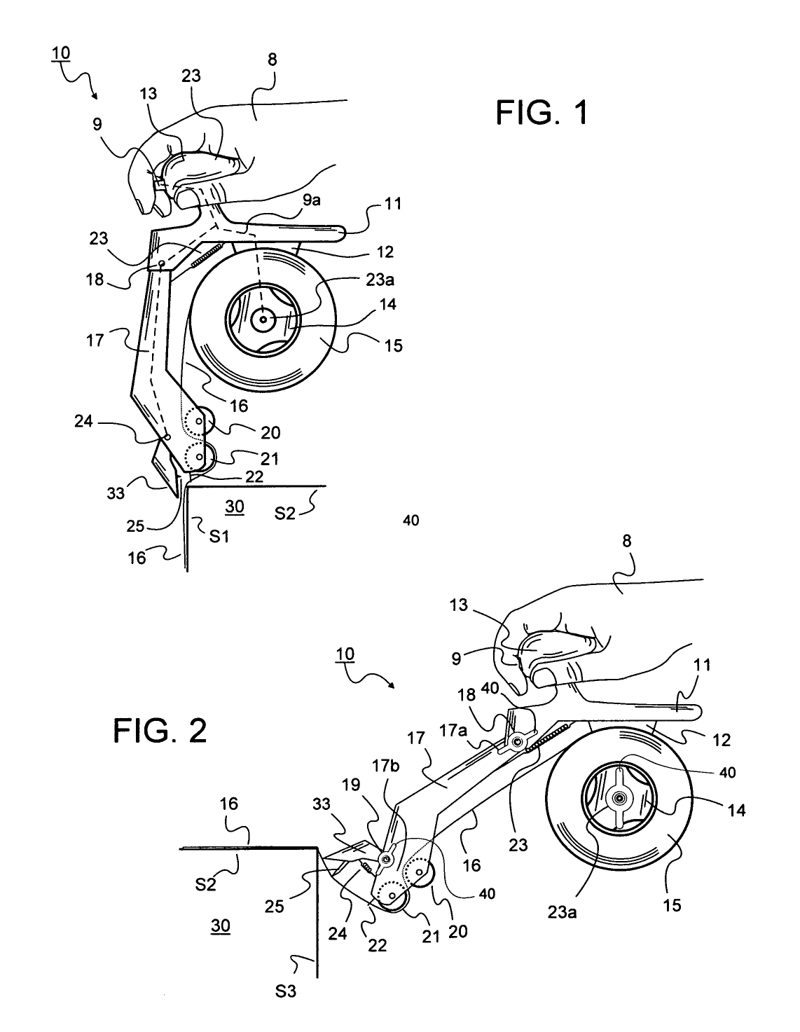

FIG. 1 illustrates a pivoting tape dispenser 10 which may be adapted for use with an adhesive tape roll 15 and/or other type of roll in accordance with the preferred embodiment described hereinafter. The exemplary construction of the pivoting tape dispenser 10 is flexible in that the pivoting tape dispenser 10 may traverse over various surfaces angled relative to each other at various degrees of orientation. FIGS. 1-2 illustrate the versatility of the angular pivoting motion of the pivoting tape dispenser 10 traversing over three surfaces in three different planes, S1, S2, S3 being angled approximately 90 degrees to each other.

In FIG. 1, the pivoting tape dispenser 10 is shown moving over a first surface plane S1 onto a second surface plane S2 situated at approximately 90 degrees from the first surface plane S1. As shown, the pivoting tape dispenser 10 is moving from a first orientation over a first surface plane S1 into a second orientation over a second surface plane S2.

FIG. 2 demonstrates the flexibility in which a dispensing end 17b of the pivoting tape dispenser 10 is adapted for use and moves over the second surface plane S2 in a second orientation, onto a third surface plane S3 in a second orientation in which third surface plane S3 is situated at approximately 90 degrees from the second surface plane S2. As shown in FIGS. 1-2, the angle of the user's hand 8 is comfortable and substantially in the same position even though the dispensing end 17b of the pivoting tape dispenser 10 has traversed over the three different planes S1, S2, S3, all angularly oriented in three drastically different planes.

The pivoting tape dispenser 10 includes a handle 11 having a grip 13 upon which a user's hand 8 may grasp. The handle 11 is attached to a base 12 that extends outward to a tape mount 14 from one side of the handle 11.

The tape mount 14 is rotationally attached at a distal end of the base 12. A tape roll 15 is disposed on the tape mount 14 with sufficient space so that the tape roll 15 disposed on the tape mount 14 and permitted to freely rotate without contacting the handle 11.

A pivot arm 17 includes a first end 17a connected to the handle 11 at a first pivot 18 point. A pair of guide rollers 20, 21, a press guard 22, and a cutting device 33 are located adjacent to an opposite, dispensing second end 17b of the pivot arm 17.

The cutting device 33 is attached at a second pivot 19 point adjacent to the dispensing second end 17b of the pivot arm 17. The cutting device 33 includes a cutting tool 25 adapted to sever a swath of tape 16 extending from the tape roll 15 through the guide roller 20, 21, over the press guard 22 and adjacent to the cutting device 33.

It is to be understood that the pivoting tape dispenser 10 may be adapted for use with any type of device stored and dispensed in the form of a roll, including but not limited to, ribbon, surgical tape, an adhesive tape, electrical tape, nylon tape, and/or any other suitable roll capable of being used and/or wound around the tape mount in accordance with the pivoting tape dispenser 10.

The handle 11 may be fastened to the base 12, and/or other parts of the pivoting tape dispenser 10, in a number of different ways, including but not limited to, welding, bonding and/or fastening screws that engage with threaded holes that align the base 12 to the handle 11. Likewise, the various rotating components, such as the tape mount 14, the guide rollers 20, 21 and the pivots 18, 19 may also be attached to the pivoting tape dispenser 10 in a variety of different ways. For example, the various rotating components may be fastened by a screw, a fly nut, a rivet, a shaft and/or any other suitable method for mounting a rotating component in accordance with the pivoting tape dispenser 10.

The pivot arm 17 may be constructed in a plurality of different configurations. Although the pivot arm 17 is shown elongated to substantially extend beyond the tape roll, it is within the scope of this invention to modify the shape and size of the pivot arm 17 to take a variety of different configurations. For example, the tape roll 15 may be mounted above the pivot arm 17 on the handle 11 instead of below the handle 11.

The pair of guide rollers 20, 21, and the press guard 22 may be disposed in various positions along the pivot arm 17. In another exemplary embodiment, only a single roller may be used. Alternatively, the rollers may be replaced by a guide suitable to align the tape 16 in accordance with this invention. The guide employed may be constructed as including an elongated aperture through which the tape 16 passes through, or the guide may be a low friction part over which the tape 16 may slide over. It is to be understood that a variety of different constructions are possible for the guide.

As shown in FIG. 1, the pivot arm 17 is urged downward toward the tape roll 15 by a first bias element 23 disposed adjacent to the base 12 of the handle 11 and the pivot arm 17. That is, the first bias element 23 may be positioned and connected between the handle 11 and the pivot arm 17 in order to bias the handle 11 and the pivot arm 17 towards one another. Alternatively, the first bias element 23 may be integrated right into the first pivot point 18 connection, such as with a helical spring and/or any suitable spring for providing the desired tension.

A second bias element 24 may be connected between the pivot arm 17 and the cutting device 33. The second bias element 24 may be integrated into the second pivot point 19 connection adjacent to the dispensing second end 17b of the pivot arm 17. Alternatively, the second bias element 24 may be employed such as shown by the first bias element 23.

A third biasing element 23a may be integrated onto the tape mount 14 to provide resistance to the rotation of the tape 16 when the tape 16 is unreeled from the tape roll 15 through the pivoting tape dispenser 10. Similar to the first 23 and second biasing 24 elements described above, the third biasing element 23a may be integrated in a variety of different ways.

The various biasing elements 23a, 23, 24 may be selected from any suitable biasing element, such as for example, a spring, a helical spring, and/or a torsion spring; integrated at the pivots 18, 19, the tape mount juncture and/or any other suitable biasing element in accordance with this invention. Likewise, the spring force for the various biasing elements 23a, 23, 24 may be integrated into the various rotating pivot points in a variety of different ways in accordance with this invention. Alternatively, more or less biasing elements may be integrated into the various components within the pivoting tape dispenser 10.

The cutting device 33 includes a cutting tool 25 for severing the tape 16. The cutting tool 25 may be actuated to sever the tape 16 through the application of a pressure applied by the user to the cutting device 33, which is then translated to a pressure on the cutting device 33 against the tape 16 disposed on the object 30 being taped. That is, when the pressure by the user is applied, the cutting tool 25 rotates against the swath of tape 16 and severs the tape 16. The cutting tool 25 may be engaged with the tape 16 by simply rotating the cutting tool 25 so that it engages with the tape 16 and shears off the swath of tape 16 applied onto the box 30. It is to be understood that the cutting device 33 may be constructed within the pivoting tape dispenser 10 in various positions and in suitable methods in order to sever the swath of tape 16.

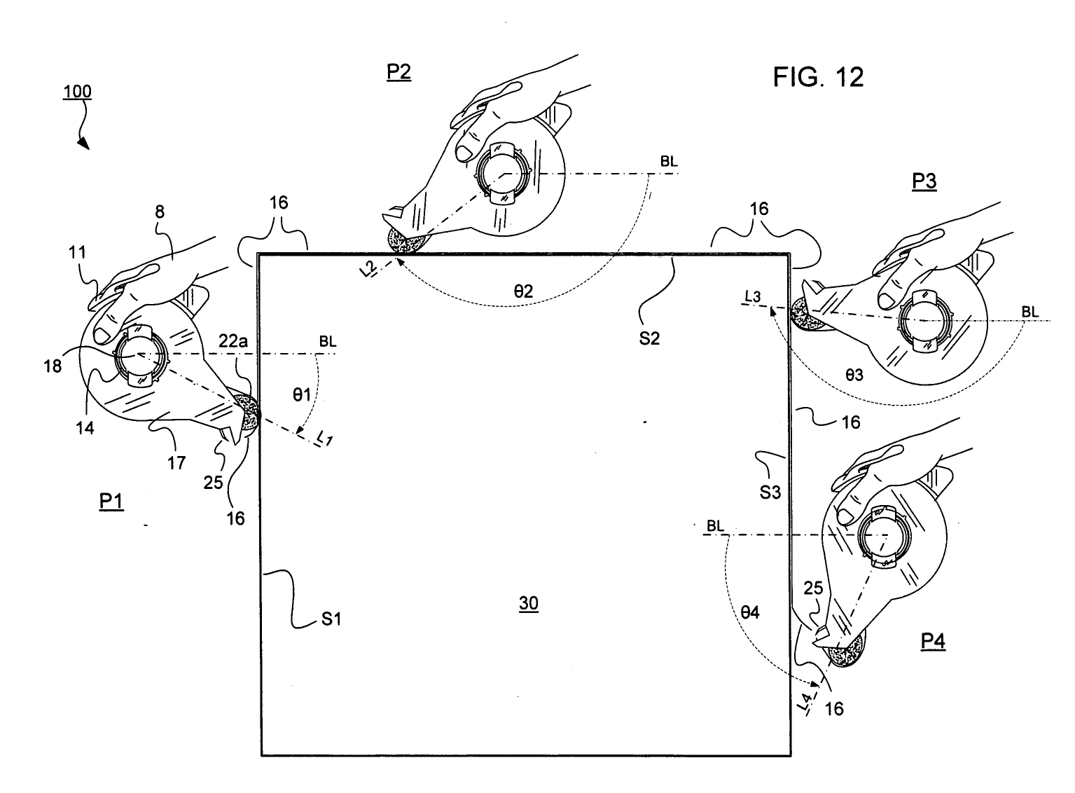

By way of example and as shown in the figures, the cutting tool 25 is shown disposed in a position located on the back side of the head of the cutting device 33. Because the pivots 18 and 19 are integrated, the far end of the pivot arm 17 is sufficiently flexible to cut from its rear side location, i.e., opposite the location of the tape mount 14. This backward cutting configuration, as shown in FIGS. 2 and 12 and described in this invention, is dramatically different from conventional tape dispensers commercially available.

The advantage of integrating at least one pivot in accordance with this pivoting tape dispenser 10, is that the method for cutting the tape 16 is not dependent on the position of the hand on the handle 11 since the pivot arm 17 is independently capable of pivoting at drastic angles relative to the handle 11. As shown in FIG. 12, from one surface to another surface, the pivot arm 17 is capable of pivoting anywhere from 0 to 90, to 180, to 270 and/or more degrees or rotation relative to various surface planes adjacent to each other. As mentioned, the pivot arm 17 is capable of pivoting to substantially more than 180 degrees relative to the handle 11 in use with little rotation to the orientation of the user's wrist and hand 8 grasping onto the handle 11 of the pivoting tape dispenser 10.

In the alternative, a trigger mechanism 9 may be incorporated onto the pivoting tape dispenser 10, such as on the handle 11 to actuate the serration operation of the cutting tool 25 against the tape 16. For example, and as illustrated in FIGS. 1 and 2, when the user 8 wishes to cut the tape 16, the user 8 may depress the trigger 9 on the grip 13 of the handle 11 to actuate the cutting tool 25. When activated, the trigger 9 will cause the cutting tool 25 to extend from safely stored within the cutting device 33 to a position where the cutting tool 25 engages and cuts the tape 16 as shown in FIG. 2.

Alternatively, the trigger mechanism 9 (and/or various trigger mechanisms (not shown)) may be integrated to provide a variety of different uses in combination with the pivoting tape dispenser 10. It is possible to adapt the trigger mechanism 9 for use as a variable tension mechanism. According to this implementation, the trigger mechanism 9 would be provided to, when depressed, provide variable tension to various components of the pivoting tape dispenser 10.

For example, the trigger mechanism 9 may be adapted to engage any one of the various rotating pivot points or elements in the pivoting tape dispenser 10 in order to vary the tension with which the relative rotation at the various joints in the pivoting tape dispenser 10 occurs. The variable tension may be provided in this manner at the guide rollers 20, 21, the pivots 18, 19 the pivoting connection between the tape mount 14 and the handle 11 and/or any other suitable location on the pivoting tape dispenser 10.

For instance, the trigger mechanism 9 may be constructed to be connected to vary the tension about the rotation of the tape mount 14 relative to the base 12. The trigger mechanism 9 may be connected to, for example, a variable braking mechanism which increases the tension in the resilient recoil resistance at a rotational juncture between the tape mount 14 and the base 12. By being able to vary the tension as desired, the tape mount 14 and hence the tape roll 15 will variably be more difficult to dispense tape 16 out onto the box 30 being taped from the resistance induced on the rotation of the tape mount 14. The advantage of providing the variable tension is to allow the user to, in a controlled manner, tightly stretch the tape over the box or object 30 as it is being dispensed to ensure a secure tight seal by the tape 16 being laid onto the box 30. The advantage being that the user can perform this function with only one hand using the pivoting tape dispenser 10, and without the need to use additional hands and/or assistance from other persons to securely stretch the tape 16 over the object 30.

Conventionally, a user of a tape dispenser would have to manually grab the unattached end of the tape adjacent to the conventional tape dispenser with another hand and then would have to separately use his second hand to manually stretch the tape over a box. The conventional process is cumbersome and prone to allowing the tape to be inadvertently cut thereby preventing a tight seal to be created. Likewise, the tape will oftentimes become crimped onto itself and not onto the box. Unfortunately, the user then has to entirely remove the last portion of tape and start all over again. Consequently, this conventional process is time consuming, inefficient and prone to numerous inefficient applications of tape over the same area.

Referring back to the trigger mechanism 9, the trigger mechanism 9 may be adapted to provide resistance by braking, i.e., by increasing the resistant strength of the spring coil of the third biasing element 23a. The trigger mechanism 9 may be attached by a cable 9a (as shown in FIG. 1) to a braking mechanism, such as a plunger or clamp (like a conventional bicycle brake). When the trigger mechanism 9 activated, a variable resistant pressure is increased against the rotating elements adjacent to the rotational connection between the base 12 and the tape mount 14 thereby making it more difficult for the tape 16 to be unrolled from the tape roll 15. As described above, similar variable resistance may be applied to any of the moving parts of the pivoting tape dispenser 10 and actuated by the trigger mechanism 9.

Another way to increase and decrease the resistance at the various rotation pivot points in the pivoting tape dispenser 10 is to provide manual tightening and loosening at those pivot points as desired. Referring back to FIG. 2, an exemplary embodiment for adjusting the tension is shown. As illustrated, various wing nuts 40 are incorporated at the pivots points 18, 19. Likewise, a wing nut 40 may also be provided at a central location of the tape mount 14. In use, the various wing nuts 40 can be independently tightened or loosened to provide a desired amount of resistance. The advantage of the adjustable tension is important to the user depending on the particular project and/or preference of the user. Conventional tape dispensers fail to provide a user with the ability to manually adjust the various rotating components. Although the wing nuts 40 are depicted as the tension adjusting mechanisms in this embodiment, it is to be understood that various other tension adjusting devices may be used that are now known, commercially available and/or later discovered in accordance with this invention.

As described above, the trigger mechanism 9 may be implemented as a button, a lever, a switch, by variably compressing/squeezing a first component against a second component of the pivoting tape dispenser 10 to provide rotational resistance and/or any other mode for providing variable selection of the rotational resistance. The trigger mechanism 9 may be connected to the cutting tool 25 in various manners, including but not limited to, a cable system, a ratchet system, a linkage system, an electronic actuator, and/or any other mechanism capable of actuating the cutting tool 25 from the trigger 9. Various cutting tool implementations may be integrated in accordance with this invention, which may range from a simple construction to a much more complex construction. Likewise, more than one trigger mechanism may be integrated to provide resistance to the various components.

Unlike conventional tape dispensers, the contour of the handle 11 and the grip 13 are configured to allow the user's wrist to rest in a comfortable ergonomic position while in use and as the tape 16 is applied to the various surfaces of a box 30 (as shown in FIG. 12) which may include right angles and/or other obtuse angles. This pivoting tape dispenser 10 is constructed in stark contrast to other commercially available, conventional tape dispensers in which a user typically has to uncomfortably and often-times painfully twist and manipulate their wrist at drastic angles in order to follow, and tape over, the obtuse surfaces of a box.

In operation, the handle 11 of the pivoting tape dispenser 10 is gripped by the user and a pressure is applied onto the surface of the object upon which the tape 16 is to be dispensed, such as a box 30. A swath of tape 16 is extended from the tape roll 15 and pulled outward over the second end 17b of the pivot arm 17 and aligned through the guide rollers 20, 21, which are positioned under the cutting device 33 on the pivot arm 17. As the pivoting tape dispenser 10 is pressed and rolled over the box 30, the first spring 23 is acted on by being stretched under the force of the user applying pressure to the pivoting tape dispenser 10 causing the pivot arm 17 to rotationally move away from the handle 11. Application of the user applied pressure translates to a force applied downward onto the tape 16. The combination of the force applied by the user and the resilient reaction force produced by the biased spring 23 allows the press guard 22 to securely press down, and scrape, over the tape 16 as the tape 16 is rolled and dispensed over the box 30.

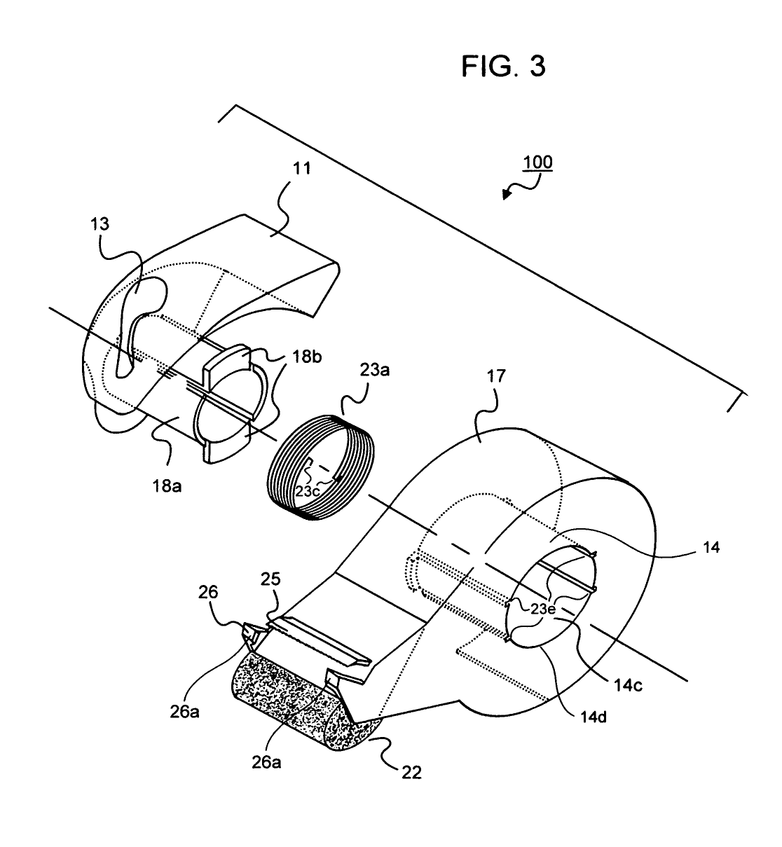

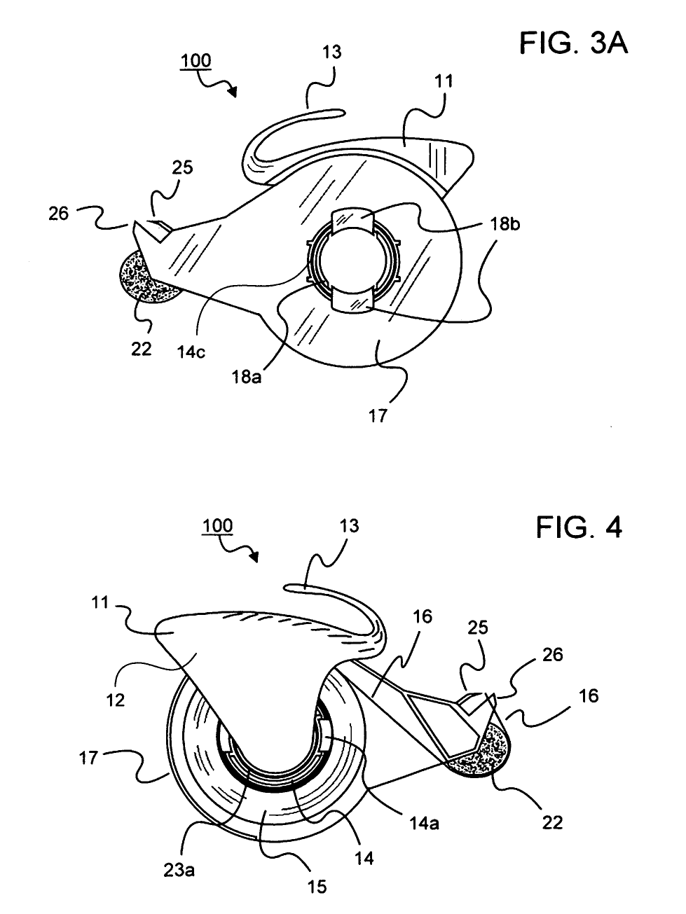

Although the exemplary embodiment shown in FIGS. 1-2 illustrates the handle 11 being connected to the pivot arm 17 at the pivot connection 18, it is to be understood as within the scope of this concept to integrate the pivot arm 17 features and functionality into the construction of the tape role mount 14 onto which the tape role 15 is mounted. FIGS. 3-12 further demonstrate this alternative.

FIG. 3 depicts an exploded perspective view of another exemplary embodiment for a pivoting tape dispenser 100 illustrating a handle 11 having a hollow pivot extension 18a axially aligned with a biasing element 23a, which in turn is axially aligned with a pivot arm opening 14c of a pivot arm 17. In this embodiment, the pivot extension 18a of the handle 11, the biasing element 23a, and the pivot arm opening 14c of a pivot arm 17 are all concentrically interconnected with each other as shown in FIGS. 3A and 4.

In particular, FIGS. 3A and 4 depict assembly views of the pivoting tape dispenser 100. The handle 11 of the pivoting tape dispenser 100 is rotationally connected to the pivot arm 17. The biasing element 23a disposed between the handle 11 and the pivot arm 17 provides a biasing force adapted to orient the handle 11 relative to the pivot arm 17 in order to provide a pressure force onto the tape 16 being dispensed onto the object 30.

The pivot arm 17 includes a cylindrical tape mount 14 disposed thereon and constructed to house and secure a tape roll 15 therein. Different from the pivoting tape dispenser 10 described above in FIGS. 1-2, the tape mount 14 is integrated onto the pivot arm 17, thereby emphasizing the versatility of this concept. The tape mount 14 on the pivot arm 17 defines a pivot arm opening 14c into which the pivot extension 18a of the handle 11 and the biasing element 23a are concentrically disposed.

In reverse assembly view shown of FIG. 4, a swath of tape 16 is extended from the tape roll 15 through the pivot arm 17 and fed over a press flange 22 and through a tape guide 26 disposed adjacent to a cutting tool 25. As shown, the tape guide includes a pair of flanges 26a adapted to align the tape 16 through the pivot arm 17. As understood, the guide and flanges 26a may be integrated onto the pivoting tape dispenser 10 as shown in FIGS. 1-2 and described above. The pivot extension 18a of the handle 11 is shown concentrically extended through the pivot arm opening 14c of the pivot arm 17 and secured in place by a plurality of pivot extension retainers 18b disposed on the pivot extension 18a which are hooked over a peripheral edge 14d of the pivot arm opening 14c.

As shown in FIG. 4, the third biasing element 23a is integrated between the tape mount 14 and the pivot arm opening 14c to provide resilient recoil resistance to the rotation of the handle 11 relative to the tape mount 14 on the pivot arm 17 when the adhesive force of the tape 16 biases the pivot arm 17 in the direction of the tape being laid to the object 30, i.e., opposite to the resilient resistant force provided by the biasing element 23a as the tape 16 is unreeled from the tape roll 15 through the pivoting tape dispenser 100. Referring to FIGS. 3 and 7, the biasing element 23a includes hooks 23c (FIG. 3) that may be secured within the various slots 23d disposed on the pivot extension 18a and the various slots 23e disposed within the tape mount 14 in order to generate the resilient resistant coil force while in use.

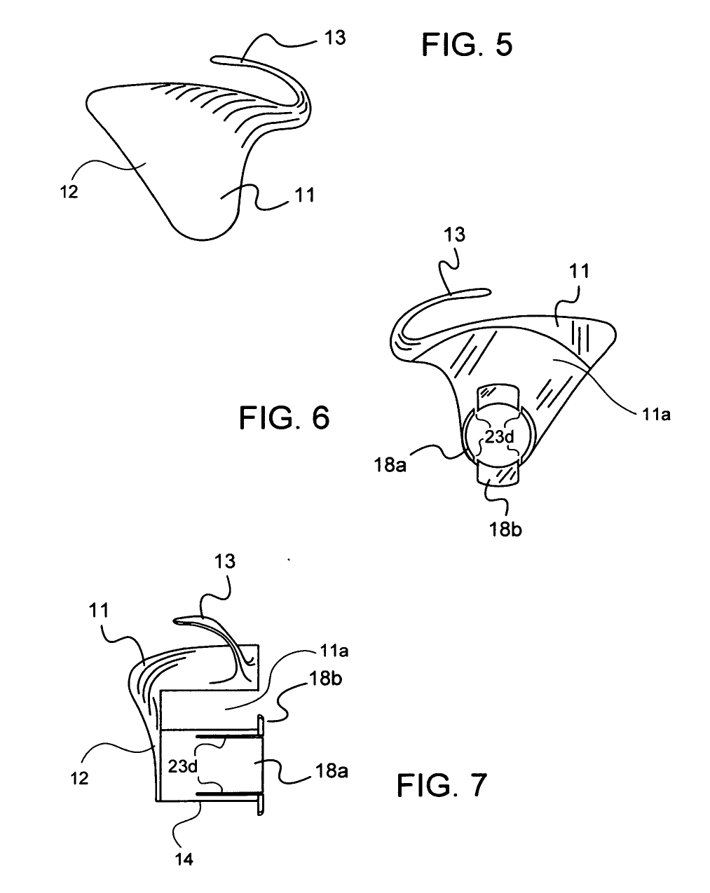

FIGS. 5-7 illustrate the exemplary handle 11 in more detail. As shown, and mentioned above, the hand grip 13 of the handle 11 may be ergonomically designed to comfortably receive a user's hand. According to one exemplary construction, the hand grip 13 may be designed to allow the web portion of a hand between the user's thumb and index finger to comfortably grasp the handle 11 and the hand grip 13. It is to be understood that handle 11 can take various other ergonomic constructions and various types of suitable ergonomic constructions may be constructed.

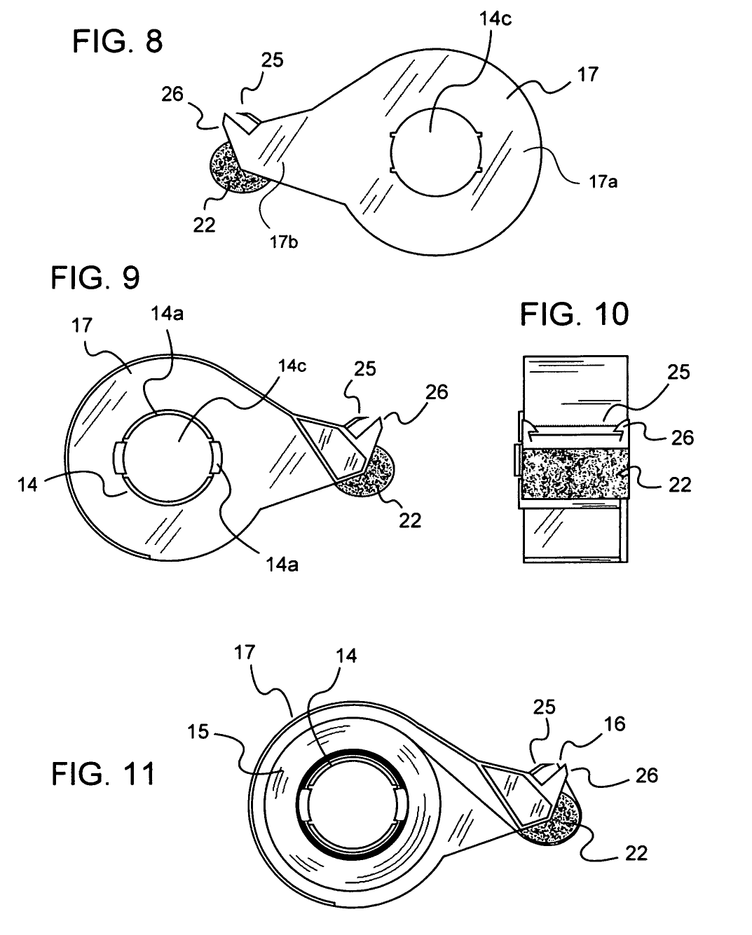

FIGS. 6 and 7 further depict an exemplary construction for the handle 11. The pivot extension 18a extends from a base 12 of the handle 11 and is constructed to receive and house the pivot arm 17 assembly (as shown in FIGS. 8-10) and the tape roll 15 disposed on the pivot arm 17.

As shown in FIG. 7, the hollow pivot extension 18a extends outward from the base 12 on one side of the handle 11 to form a recessed housing 11a into which the pivot arm 17 and the tape roll 15 may be disposed substantially flush within the recessed housing 11a of the handle 11. The pivot extension 18a is designed to extend through the pivot arm opening 14c (as shown in FIGS. 6 and 7) in the pivot arm 17. Once the pivot extension 18a has been extended through the pivot arm opening 14c, the retainers 18b disposed at the end of the pivot extension 18a secure the pivot extension 18a firmly from reversing back out from within the pivot arm opening 14c. In position, the handle 11 is capable of pivoting about the pivot extension 18a within the pivot arm opening 14c.

FIGS. 8-10 show the exemplary pivot arm 17 assembly. In FIG. 8, the pivot arm 17 is configured in a somewhat pear shape. The larger bulbous end 17a portion of the pivot arm 17 is adapted to receive and house the tape roll 15. The narrower dispensing end 17b portion of the pivot arm 17 is adapted to integrate the cutting tool 25, the tape guide 26 and the press flange 22.

FIGS. 8-11 illustrate the exemplary compressible guide 22a. In FIG. 8, the rollers 20, 21 shown in FIGS. 1-2 are replaced by the compressible guide 22a. In use, the compressible guide 22a is dragged over the surface of the box 30, and the compressible guide 22a aligns and presses the tape 16 onto the box 30 as it is being taped. The compressible guide 22a may be composed of a variety of different materials, including but not limited to, a hard sponge, a resilient polymer, a metal and/or any other composite capable of being flexibly compressed to apply a pressure to the tape 16 being dispensed against the box 30 while in use.

As shown in FIG. 9, the tape mount 14 is constructed as a hollow cylindrical extension having a pair of tape mount retainers 14a. The hollow cylindrical extension includes a pivot arm opening 14c into which the pivot extension 18a of the handle 11 is disposed and secured as mentioned above.

FIG. 10 depicts a detailed view of the narrower dispensing end 17b portion of the pivoting arm 17 including the press flange 22, the tape guide 26 and the cutting tool 25. Although the cutting tool 25 is shown here as a thin piece of a sharp serrated material, it is to be understood that the cutting tool 25 may be implemented in a variety of different ways utilizing numerous cutting implements commonly known. Likewise, the tape guide 26 may take a variety of different forms suitable for guiding the tape 16 through the dispensing end 17b of the pivot arm 17. Likewise, the press flange 22 may be implemented as a flat scraping tool, and/or any type of suitable implement capable of compressing the tape 16 onto the surface of the object 30 being taped.

As shown in FIG. 11, the tape roll 15 is placed over the extended hollow cylindrical tape mount 14. In use, the tape roll 15 is adapted to be secured and to rotate around an outer diameter of the extended hollow cylindrical tape mount 14. In assembly, the tape roll 15 is positioned over the outer diameter of the extended hollow cylindrical tape mount 14 so that the tape roll 15 is substantially contained within the outer walls of the handle 11 and the pivot arm 17.

Referring back to the assembly shown in FIGS. 3 and 4, when the pivot extension 18a of the handle 11 is secured within the pivot arm opening 14c of the pivot arm 17, the handle 11 is free to rotate relative to the pivot arm 17 under the bias force applied by the biasing element 23a. It should also be noted that the biasing element 23a need not be present and other constructions may be integrated to create a desired tension between the handle 11 and the pivot arm 17. For example, the user may manually grasp onto the handle 11 and the pivot arm 17 and manually create the desired tension between the two parts rotating relative to each other. In use, the dispensing end 17b portion located at the narrow end of the pivot arm 17 is allowed to rotate over the surface of the item (such as a box 30) being taped.

FIG. 12 illustrates the pivoting tape dispenser 100 in use about a box 30 in accordance with this invention. The pivoting tape dispenser 100 is depicted in four exemplary positions P1, P2, P3, and P4 over three surfaces S1, S2 and S3 of an exemplary box 30. The second surface S2 is shown oriented approximately 90 degrees from the first surface S1, and the third surface S3 is shown oriented at approximately 90 degrees from the second surface S2.

In FIG. 12, the handle 11 of the pivoting tape dispenser 100 is secured by the user's hand 8. As shown throughout the various positions, the angle of the user's hand 8 is substantially unchanged as the pivoting tape dispenser 100 moves throughout the four exemplary positions P1, P2, P3, and P4 and traverses over the three surfaces S1, S2 and S3 of the box 30.

As shown in position P1, the long length (labeled “L1”) of the pivot arm 17 rotates at a first pivot 18 and is oriented at a first angle θ1 relative to a baseline point of reference (labeled “BL”). As the pivoting tape dispenser 100 is pulled over the first surface S1 of the box 30, the press guard 22 guides and compresses the tape 16 onto the first side S1 of the box 30. At the first corner where surfaces S1 and S2 meet, the press guard 22 transitions into the second position P2 and onto the second surface S2 of the box 30.

As shown in position P2, the long length (labeled “L2”) of the pivot arm 17 rotates at the first pivot 18 and is oriented at a second angle θ2 relative to the baseline point of reference BL. The second surface S2 is angled at approximately 90 degrees to the previous position on the first surface S1. The pivot arm 17 rotates clockwise about the first pivot 18 into the second position P2 which is approximately 90 degrees from the position shown in position P1. As shown, the position of the handle 11 and of the user's wrist in the second position P2 remain substantially the same as in the first position P1. At the second corner where surfaces S2 and S3 meet, the press guard 22 transitions from position P2 on the second surface S2 into position P3 as shown on the third surface S3 of the box 30.

As shown in position P3, the long length (labeled “L3”) of the pivot arm 17 rotates at the first pivot 18 and is oriented at a third angle θ3 relative to the baseline point of reference BL. The third surface S3 is angled at approximately 40 degrees to the previous position on the second surface S2. The pivot arm 17 again rotates clockwise about the first pivot 18 while the position P3 of the handle 11 and the user's wrist still remain in substantially the original position as shown in positions P1 and P2.

Position P4 shows the cutting end position of the tape dispensing process in which the tape 16 has been disposed continuously over the three sides S1, S2, S3 of the box. As shown in the cutting position P4, the long length (labeled “L4”) of the pivot arm 17 rotates counter-clockwise about the first pivot 18 and is oriented at a fourth angle θ4 relative to the baseline point of reference BL. In position P4, the cutting tool 25 is engaging the tape 16 and serrating the tape 16 at a desired end.

As demonstrated, the pivot arm 17 of the pivoting tape dispenser 100 flexibly rotates over the various surfaces S1, S2, S3 with ease and without the user's wrist having to make the awkward twists and turns as would a user using a conventional tape dispenser. The integrated pivot 18 on the pivoting tape dispenser 100 alleviates the traditionally painful effect experienced by a user employing the use of a convention inflexible rigid tape dispenser in which the user is forced to continuously twist and contort their wrist over each surface of the box 30.

The pivoting tape dispensers 10, 100, 200 may be manufactured from a variety of different suitable materials, including but not limited to, a polymer, metal, and/or any other composite suitable for providing the requisite rigidity during application of its use in accordance with this concept.

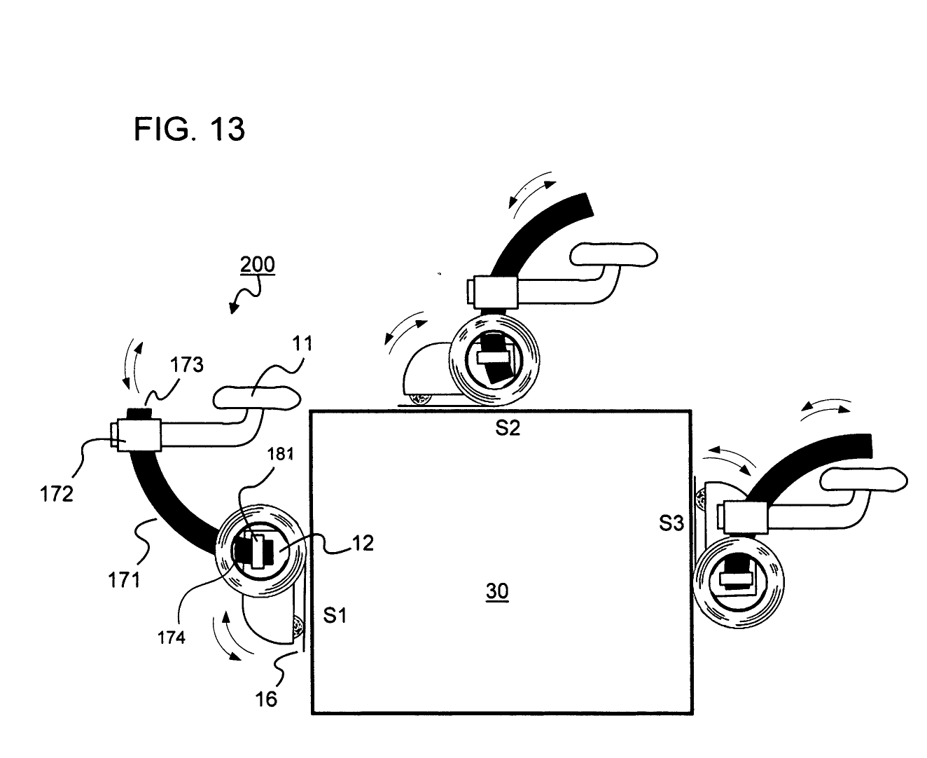

FIG. 13 depicts another embodiment for a pivoting tape dispenser 200 in which the pivoting arm 171 is constructed to pivotally slide and extend or contract at various arcuate angles. As shown, the pivoting arm 171 is not pivotally fixed at a first end 173 and is permitted to extendably slide in and out of a slide guide 172. The second end 174 of the pivot arm 171 includes a first connection point 181. According to this construction, the pivot arm 171 extends or contracts to a suitable length to reach the surface of the box 30 being taped. Likewise, the first connection point 181 enables the sliding pivot arm 171 to rotate from one surface (e.g., surface S1) of the box 30 to a second surface (e.g., surface S2) of the box 30 without requiring the user's hand 8 to substantial twist and/or turn in response to the changing surface angle of the box 30 being taped.

In the alternative, the pivoting tape dispenser 200 may be constructed to include a helical-type spring at the first connection point 181 so that the pivoting arm 171 can resiliently pivot at the first connection point 181. According to this construction, the pivoting arm 171 and the first connection point 181 are pivotally attached and the pivoting arm 171 does not slide relative to the first connection point 181, but instead pivots concentric about the first connection point 181 and/or an axis located approximately at the center of the tape roll 15. When the first connection point 181 of the tape dispenser 200 moves into a rear-facing position, a resilient biasing element may trigger a cutting tool (not shown) located near the first connection point 181 to be automatically engaged to cut the swath of tape 16 dispensed.

Furthermore, the cutting tool 25 may be fixed in a position perpendicularly rearward opposite to the direction in which a head of the pivoting arm 171 is laying the tape over the box 30. As such, the cutting tool 25 may appear to protrude rearward and shown in FIGS. 2 and 12. The advantage of this configuration is to prevent the user from accidentally cutting herself since the tape 16 will not cross a cutting path until the user is ready to cut the swath of tape 16 at the bottom of the near side of the box 30 as shown in FIG. 12.

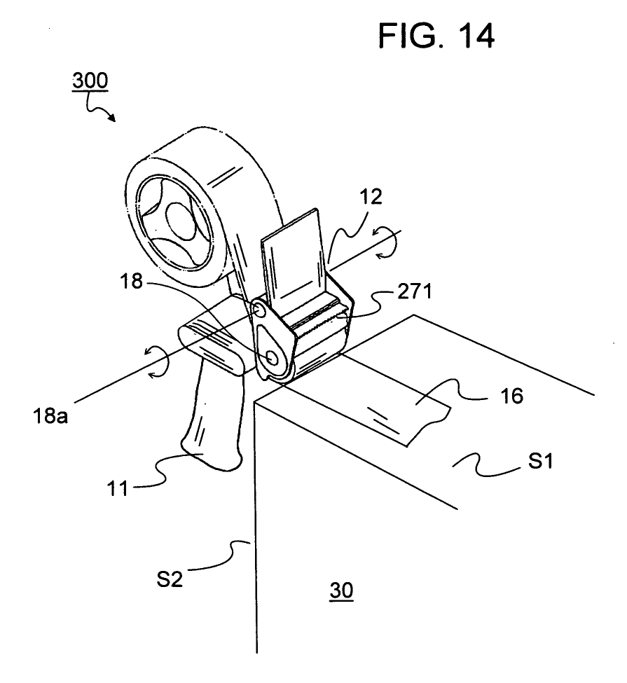

FIG. 14 is an example of yet another embodiment for the pivoting tape dispenser 300 in which a pivot arm 271 assembly is redesigned to include a first pivot 18 disposed between a base 12 and the pivot arm 271. The pivot arm 271 is capable of rotating about an axis 18.

In use, the user may hold on to the handle 11 and may more flexibly dispense tape 16 along a surface of a box 30. Turning the corner from a first surface S1 to a second surface S2 will be easier and more comfortable on the user's wrist 8 since the pivot arm 271 can rotate to the new angle of the second surface S2 without under stress on the user's wrist, which would, with conventional tape dispensers require the user to turn his wrist 8 uncomfortably at a 90 degree angle to tape onto the new angle surface S2, which is angled 90 degrees from the first surface S1.

It will be recognized by those skilled in the art that changes or modifications may be made to the various pivoting tape dispenser 10, 100, 200, 300 embodiments described above without departing from the broad inventive concepts of the invention. It is understood therefore these exemplary embodiments are not intended to be limiting, but are intended to cover all modifications and changes within the scope and spirit of this concept.

What is claimed is:

1. A pivoting tape dispenser comprising:
an ergonomic handle including a tape roll mount connected to the handle at a first pivot, wherein a tape roll is concentrically disposed on the tape roll mount;
a pivot arm having a first end and a second dispensing end, wherein the first end is connected to the handle at a second pivot, and a swath of tape extends from the tape roll to the second dispensing end on the pivot arm; and
an adjustable bias element disposed at the second pivot being adapted to provide variable resistance to the rotation of the pivot arm relative to the handle,
where, in use, the angle of the handle remains substantially unchanged in position as the swath of tape being dispensed from the second dispensing end of the pivot arm is adapted to traverse onto various surfaces oriented at various angles upon which the swath of tape is being applied.

2. The pivoting tape dispenser recited in claim 1, wherein the second dispensing end of the pivot arm further comprise:
a guide adapted to align the swath of tape out of the second dispensing end of the pivot arm;
a press guard adapted to press the swath of tape onto an object being taped as the swath of tape exits the second dispensing end of the pivot arm; and
a cutting device adapted to sever the swath of tape.

3. The pivoting tape dispenser recited in claim 1, wherein the adjustable bias element may be comprised of at least one of: a spring, a screw, a fly nut and a braking device.

4. The pivoting tape dispenser recited in claim 1, wherein additional adjustable bias elements may be provided at:
a first location where the tape roll mount is connected to the handle; and
a second location where the cutting device is attached to the pivot arm in order to provide resistance to the rotation of the cutting device as the swath of tape is unreeled from the tape roll.

5. The pivoting tape dispenser recited in claim 1, wherein the pivoting tape dispenser further comprises:
a triggering mechanism connected to at least one of: the adjustable bias elements, and the pivots.

6. A variable tension tape pivoting dispenser comprising:
an ergonomic handle including a first pivot point;
a base portion extending from the ergonomic handle to a tape roll mount that receives a tape roll;
a pivot arm including a first end rotationally attached to the first pivot point and a dispensing second end;
an adjustable bias element disposed at the first pivot point being adapted to provide variable resistance to the rotation of the pivot arm relative to the ergonomic handle;
a pair of guide rollers disposed adjacent to the dispensing second end of the pivot arm being adapted to guide a swath of tape pulled from the tape roll to a dispensing end of the pivot arm;
wherein the swath of tape is fed over a press flange disposed adjacent to a cutting tool, and
where in use the ergonomic handle remains substantially in one position while the dispensing end of the pivot arm is adapted to rotate through a range of various angles suitable to lay the swath of tape onto an object being taped; and
a variable tension trigger mechanism includes an actuator connected to a brake, which when the variable tension trigger mechanism is depressed, a tension pressure applied to at least one of the rotating components on the variable tension tape pivoting dispenser can be gradually increased or decreased thereby making it harder or easier, respectively, to turn the rotating component.

7. A pivoting tape dispenser that dispenses a swath of tape from a tape role disposed therein, comprising:
a handle;
a pivot arm having a first end and a second dispensing end, wherein the first end is connected to the handle at a pivot, wherein the swath of tape extends from the tape roll to the second dispensing end of the pivot arm; and
an adjustable bias element disposed at the pivot that is adapted to provide variable resistance to the rotation of the pivot arm relative to the handle,
where, in use, the angle of the handle remains substantially unchanged in position as the pivot arm pivots over various surfaces in order to align and dispense the swath of tape over the various surfaces whose surfaces are angled different from each other.

8. The pivoting tape dispenser recited in claim 7, wherein the handle includes a base that extends outward to a tape mount from one side of the handle, wherein the tape mount is rotationally attached at a distal end of the base.

9. The pivoting tape dispenser recited in claim 7, wherein the second dispensing end of the pivot arm further comprises:
a trigger mechanism adapted to perform an operation;
a guide adapted to align the swath of tape out of the second dispensing end of the pivot arm;
a press guard adapted to press the swath of tape onto an object being taped as the swath of tape exits the second dispensing end of the pivot arm; and
a cutting device adapted to sever the swath of tape extending from the second dispensing end of the pivot arm.

10. The pivoting tape dispenser recited in claim 9, wherein the guide is a pair of rollers.

11. The pivoting tape dispenser recited in claim 9, wherein the guide includes flanges provided to align the swath of tape through the second dispensing end of the pivot arm.

12. The pivoting tape dispenser recited in claim 7, wherein the adjustable bias element may be at least one of: a spring; a screw; a fly nut and a braking device.

13. The pivoting tape dispenser recited in claim 7, wherein additional adjustable bias elements are provided at:
a first location where the roll mount is attached to the base of the handle; and
a second location where the cutting device is attached to the pivot arm in order to provide resistance to the rotation of the tape roll when the swath of tape is unreeled from the tape roll.

14. The pivoting tape dispenser recited in claim 7, wherein when the trigger mechanism is actuated, a cutting tool extends from a safely storage position within the cutting device to a position where the cutting tool engages and cuts the swath of tape.

15. The pivoting tape dispenser recited in claim 7, wherein the operation performed by the trigger mechanism provides tension to: the guide rollers or the pivots.

16. The pivoting tape dispenser recited in claim 7, wherein the trigger mechanism may be implemented as a button, a lever, and a switch.

17. The pivoting tape dispenser recited in claim 16, wherein the trigger mechanism may be actuated through a cable system, a ratchet system, a linkage system, and an electronic actuator.

18. The pivoting tape dispenser recited in claim 7, wherein the handle may be ergonomically designed to comfortably receive a user's grasp.
